(19) United States
(12) Patent Application Publication
(10) Pub. No.: US 2017/0155488 A1
(43) Pub. Date: Jun. 1, 2017

(54) LC-PUCCH for Narrowband UEs using Both Slots in a Subframe

(71) Applicant: Telefonaktiebolaget LM Ericsson (publ), Stockholm (SE)

(72) Inventors: Vidit Saxena, Solna (SE); Johan Bergman, Stockholm (SE); Yufei Blankenship, Kildeer, IL (US)

(21) Appl. No.: 15/111,432

(22) PCT Filed: May 16, 2016
(86) PCT No.: PCT/SE2016/050439

§ 371 Date: Jul. 13, 2016

Related U.S. Application Data
(60) Provisional application No. 62/161,974, filed on May 15, 2015.

(51) Int. Cl. H04L 5/00; H04W 72/04

(52) U.S. Cl. CPC H04L 5/0053; H04W 72/0446

(57) ABSTRACT

There is disclosed a method for operating a terminal (10) in a wireless communication network. The terminal is a narrowband terminal (10) comprising radio circuitry (22), the method comprising transmitting uplink control information on resources, the resources comprising at least one subcarrier in the first slot of a subframe and at least one subcarrier in the second slot of the subframe, such that the subcarrier in the second slot of the subframe is within the bandwidth of the radio circuitry (22) of the narrowband terminal (10) used for transmitting in the first slot of the subframe.

There are also disclosed related methods and devices.

### TECHNICAL FIELD

The present disclosure pertains to wireless communication technology, in particular to narrowband technology.

### BACKGROUND

The concept of narrowband technology is becoming more and more prominent in the context of wireless communication, in particular in the context of Machine-To-Machine (M2M) communication and/or Internet of Things (IoT). However, the use of narrowband technology entails limitations on signaling, which may need new approaches, e.g. in the context of current-state LTE, to adapt to.

### SUMMARY

It is an object of the present disclosure to provide approaches facilitating efficient transmission of Uplink Control Information (UCI) for narrowband systems.

There is disclosed a method for operating a terminal in a wireless communication network. The terminal is a narrowband terminal comprising radio circuitry. The method comprises transmitting uplink control information on resources. The resources comprise at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.

Moreover, there is proposed a terminal for a wireless communication network, wherein the terminal is a narrowband terminal comprising radio circuitry. The terminal further is adapted for transmitting uplink control information on resources, the resources comprising at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.

A method for operating a network node in a wireless communication network is also suggested. The method comprises configuring a narrowband terminal comprising radio circuitry for transmitting uplink control information on resources. The resources comprise at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.

There is also discussed a network node for a wireless communication network, the network node being adapted for configuring a narrowband terminal which comprises radio circuitry for transmitting uplink control information on resources. The resources comprise at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.

Furthermore, a program product comprising code executable by control circuitry is considered. The code causes the control circuitry to carry out and/or control any one or any combinations of the methods described herein.

A storage medium storing a program product as disclosed herein is also proposed.

With the approaches described herein, uplink control information (UCI) transmission by narrowband terminals may be performed in different slots of a subframe without the need to retune the narrowband radio circuitry, facilitating efficient use of (uplink) resources.

### BRIEF DESCRIPTION OF THE DRAWINGS

The drawings are provided to illustrate concepts and approaches of the disclosure and are not intended as limitation. The drawings comprise:

FIG. 1, showing the LTE time-domain structure;

FIG. 2, showing a radio frame structure;

FIG. 3, showing an exemplary downlink subframe;

FIG. 4, showing an arrangement of UCI resources;

FIG. 5, showing PUCCH format 1 (normal cyclic prefix);

FIG. 6, showing allocation of resource blocks for PUCCH;

FIG. 7, showing exemplary LC-PUCCH locations within a subframe;

FIG. 8, showing multiplexing of LC-PUCCH for LC/CE UEs and legacy PUCCHs;

FIG. 9, showing an example of frequency hopping of LC-PUCCH across subframes;

FIG. 10, showing an example of multiplexing of two LC-PUCCHs for LC/CE UEs;

FIG. 11, showing an example of multiplexing of an LC-PUCCH and a PUSCH in an UL subframe;

FIG. 13, showing an example of multiplexing of an LC-PUCCH and a PUSCH in an UL subframe;

FIG. 13, showing an exemplary terminal; and

FIG. 14, showing an exemplary network node.

### DETAILED DESCRIPTION

In this disclosure, the terms base station and network node may be freely interchanged, unless explicitly stated otherwise. A network node may in particular be a radio node. Any device providing the functionality of a network node described herein may be considered a network node or base station. However, a network node or base station may provide additional functionality, in particular control and/or scheduling functionality. A terminal may be any kind of user equipment (UE), and may be considered a terminal if it provides the functionality associated to a terminal described herein.

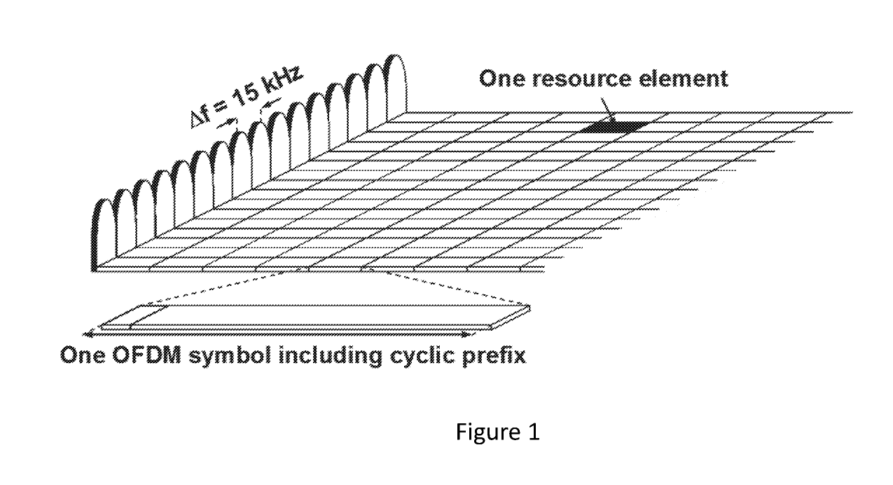

LTE uses OFDM in the downlink and DFT-spread OFDM in the uplink. The basic LTE downlink physical resource can thus be seen as a time-frequency grid as illustrated in FIG. 1, where each resource element corresponds to one OFDM subcarrier during one OFDM symbol interval.

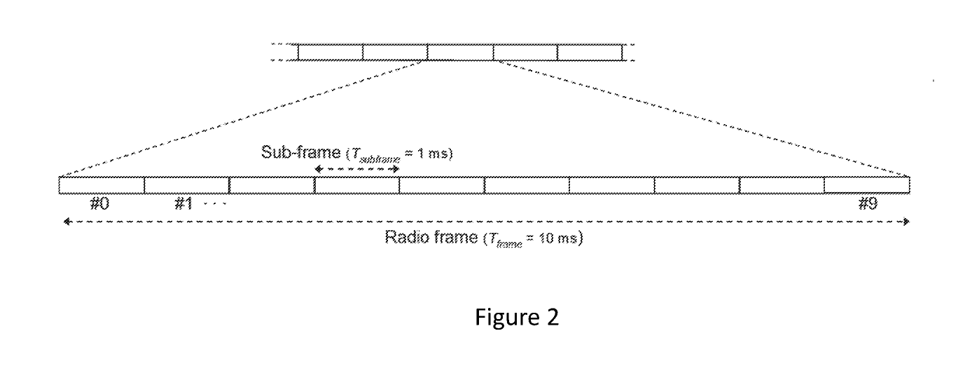

In the time domain, as shown in FIG. 2, LTE downlink transmissions are organized into radio frames of 10 ms, each radio frame consisting of ten equally-sized subframes of length T_{subframe}=1 ms. Each subframe is divided into two slots, each of which may comprise a number of symbols, e.g. 7 (each symbol having a symbol time length).

Furthermore, resource allocation is typically described in terms of resource blocks (RBs, in particular physical resource blocks, PRBs), where a resource block for LTE for example corresponds to one slot (0.5 ms) in the time domain and 12 contiguous subcarriers in the frequency domain. Resource blocks are numbered in the frequency domain, starting with 0 from one end of the system bandwidth.

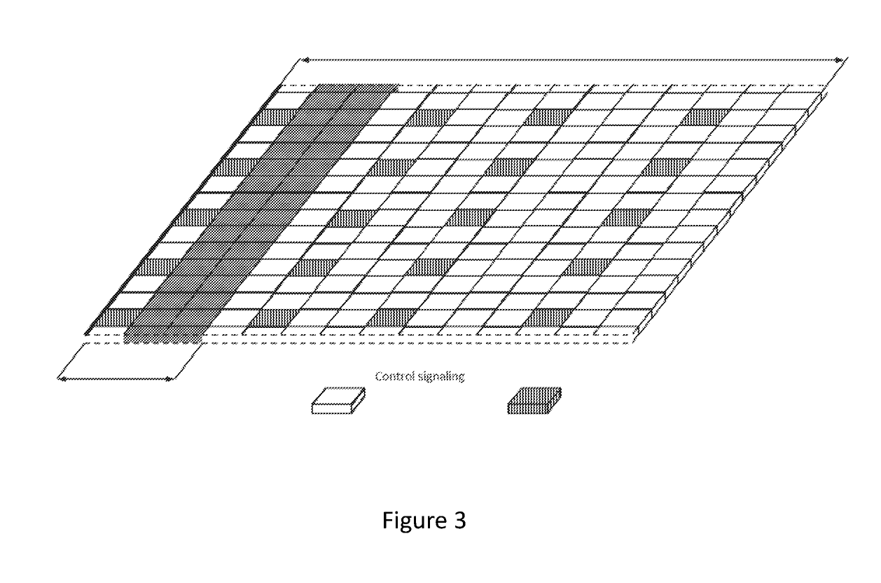

Downlink transmissions are dynamically scheduled, i.e., in each subframe (or a pre-defined control interval) the base station transmits control information and/or allocation data (in particular downlink-related data) pertaining to scheduling, in particular downlink scheduling, which may pertain to which terminals data is to be transmitted and/or in which resource blocks the data is to be transmitted, in the current downlink subframe. This control signaling is typically transmitted in the first 1, 2, 3 or 4 OFDM symbols in each subframe. A downlink system with 3 OFDM symbols as control is illustrated in FIG. 3.

LTE uses hybrid-ARQ (HARQ), where, after receiving downlink data in a subframe, the terminal attempts to decode it and reports to the base station whether the decoding was successful (ACK) or not (NAK). In case of an unsuccessful decoding attempt, the base station can retransmit the erroneous data. For this process, HARQ-identifiers may be utilized, which may be individually assigned to blocks of data undergoing transmission, and may be reused after a block has been identified and/or signaled (by the terminal) to be successfully transmitted (ACK).

Uplink control information, in particular uplink control signaling from the terminal to the base station, may generally comprise
hybrid-ARQ signaling, e.g. acknowledgements/NAKs, for received downlink data; and/or
terminal reports related to downlink channel conditions, e.g. used as assistance for the downlink scheduling, e.g., measurement reports or reports based on measurements, e.g. pertaining to CSI/CQI; and/or
scheduling requests, e.g. indicating that a terminal request and/or needs uplink resources, e.g. for uplink data transmissions.

If the terminal has not been assigned an uplink resource for data transmission, the L1/L2 control information (channel-status reports, hybrid-ARQ acknowledgments, and scheduling requests) may be transmitted in uplink resources (resource block/s) specifically assigned for uplink L1/L2 control on PUCCH.

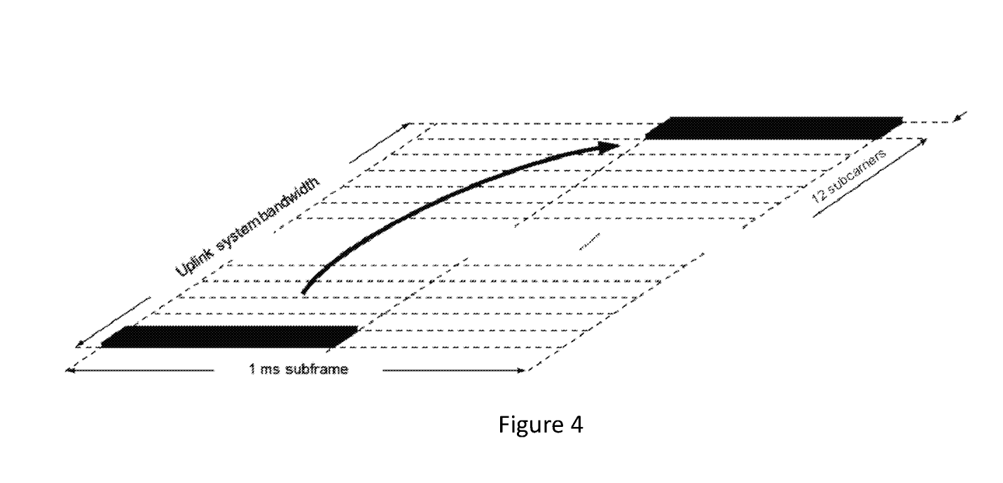

As illustrated in FIG. 4, these resources are located at the edges of the total available resource or carrier or cell bandwidth (the frequency bandwidth assigned or associated to a resource, e.g. resource block, and/or cell and/or carrier, which may be defined by the subcarrier arrangement within a carrier and/or cell and/or resource block).

Each such resource may, e.g. in LTE, consist of twelve “subcarriers” (one resource block) within each of the two slots of an uplink subframe. In order to provide frequency diversity, these frequency resources are subjected to frequency hopping on the slot boundary, e.g., one “resource” consists of 12 subcarriers at the upper part of the spectrum within the first slot of a subframe and an equally sized resource at the lower part of the spectrum during the second slot of the subframe or vice versa. If more resources are needed for the uplink L1/L2 control signaling, e.g. in case of very large overall transmission bandwidth supporting a large number of users and/or carriers, additional resources blocks can be assigned next to the previously assigned resource blocks.

The reasons for locating the PUCCH resources at the edges of the overall available spectrum are at least two-fold:

Together with the frequency hopping described above, this maximizes the frequency diversity experienced by the control signaling; and/or assigning uplink resources for the PUCCH at other positions within the spectrum, i.e. not at the edges, would have fragmented the uplink spectrum, making it impossible or at least very difficult to assign very wide transmission bandwidths to single (mobile) terminal and still retain the single-carrier property of the uplink transmission.

The bandwidth of one resource block during one subframe often is too large for the control signaling needs of a single terminal. Therefore, to efficiently exploit the resources set aside for control signaling, multiple terminals can share the same resource block. This may be done by assigning the different terminals different orthogonal phase rotations of a cell-specific length-12 frequency-domain sequence. A linear phase rotation in the frequency domain is equivalent to applying a cyclic shift in the time domain. Thus, although the term “phase rotation” is used herein, the term cyclic shift is sometimes used with an implicit reference to the time domain.

The resource used by a PUCCH is therefore not only specified in the time-frequency domain by the resource-block pair, but also by the phase rotation applied. Similarly to the case of reference signals, e.g. in LTE, there are up to twelve different phase rotations specified, providing up to twelve different orthogonal sequences from each cell-specific sequence. However, in the case of frequency-selective channels, not all the twelve phase rotations can be used if orthogonality is to be retained. Typically, up to six rotations are considered usable in a cell.

FIG. 4 shows uplink L1/L2 control signaling transmission on PUCCH.

As mentioned above, uplink L1/L2 control signaling may include hybrid-ARQ acknowledgements, channel-status reports and/or scheduling requests. Scheduling requests or hybrid-ARQ feedback consisting of 1 or 2 bits may be transmitted over the so-called PUCCH format 1, 1A or 1B respectively. CSI reports and larger number of hybrid-ARQ bits may use formats 2 and 3 respectively.

PUCCH format 1A/1B is discussed in the following.

Hybrid-ARQ acknowledgements are used to acknowledge the reception of one (or two in case of spatial multiplexing, the HARQ-identifiers of which may be interlinked) transport blocks in the downlink.

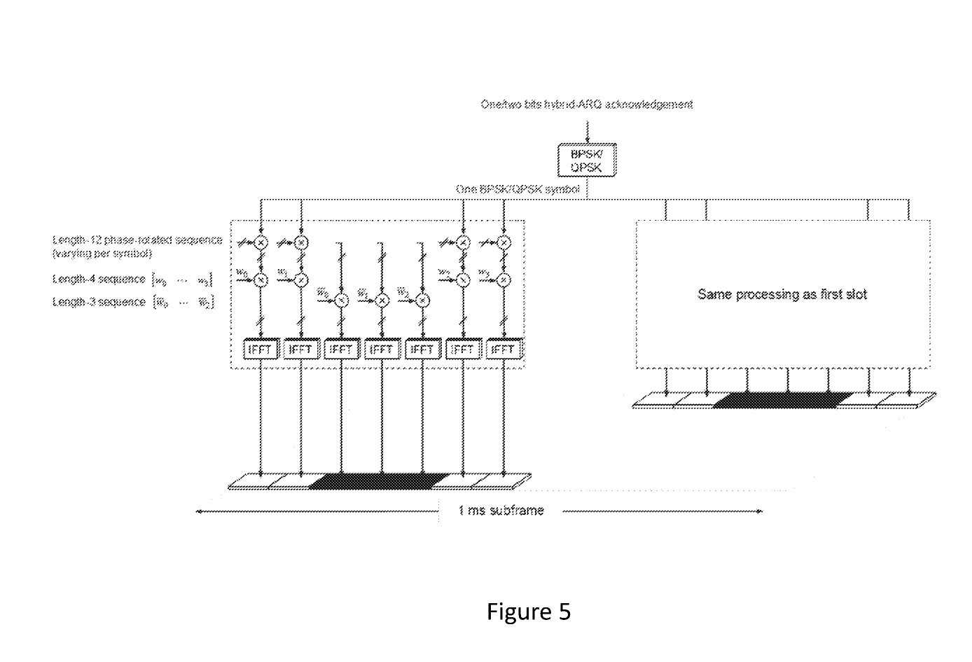

PUCCH format 1A/1B uses the structure in the two slots of a subframe as illustrated in FIG. 5. For transmission of a hybrid-ARQ acknowledgement, the single hybrid-ARQ acknowledgement bit is used to generate a BPSK symbol (in case of downlink spatial multiplexing the two acknowledgement bits are used to generate a QPSK symbol). The modulation symbol is then used to generate the signal to be transmitted in each of the two PUCCH slots.

A PUCCH format 1A/1B resource, used for hybrid-ARQ acknowledgement, may be represented by a single scalar resource index. From the index, the physical resources in each slot, phase rotation and the orthogonal cover sequences are derived or derivable.

As mentioned above, a PUCCH resource can be represented by an index. For hybrid-ARQ transmission, the resource index to use for transmission of the hybrid-ARQ acknowledgement is given implicitly by the downlink control signaling used to schedule the downlink transmission to the terminal. Thus, the resources to use for an uplink hybrid-ARQ acknowledgement vary dynamically and depend on the downlink control channel used to schedule the terminal in each subframe.

In addition to dynamic scheduling by using the PDCCH, there also exists the possibility to semi-persistently schedule a terminal according to a specific pattern. In this case, the configuration of the semi-persistent scheduling pattern includes information on the PUCCH index to use for the hybrid-ARQ acknowledgement.

Thus, to summarize, PUCCH format 1A/1B resources may be split into two parts:

A semi-static part, used for scheduling requests and hybrid-ARQ acknowledgements from semi-persistently users. The amount of resources used for the semi-static part of PUCCH 1A/1B resources does not vary dynamically.

A dynamic part, used for dynamically scheduled terminals. As the number of dynamically scheduled terminals varies, the amount of resources used for the dynamic PUCCHs varies.

Resource-block mapping for PUCCH is discussed in the following. The signals described above are, as already explained, transmitted on a resource-block pair with one resource block in each slot (of a subframe). The resource-block pair to use is determined from the PUCCH resource index. The physical resource blocks to be used for transmission of PUCCH in slot nₛ are given by

$${n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix}$$

where m depends on the PUCCH resource index.

The PUCCH resource index to use for transmitting ACK/NACK for received data is implicitly derived from the downlink control signaling. Specifically, the PUCCH resource index is a function of lowest control channel element (CCE) used to construct the PDCCH signal indicating the received data. In case of downlink control signaling over EPDCCH, the PUCCH resource index is derived from lowest enhanced CCE (ECCE) used to construct the EPDCCH. It may be considered to utilize:

PUCCH resource index=f(Lowest CCE/ECCE index)

For a two antenna port transmission, the PUCCH resource index for the second antenna port is simply incremented by 1 compared to the first antenna port, for which the above-presented relation may hold.

Multiple resource-block pairs can be used to increase the control-signaling capacity;

when one resource-block pair is full, the next PUCCH resource index may be mapped to the next resource-block pair in sequence. The mapping is in principle done such that PUCCH format 2 (channel-status reports) is transmitted closest to the edges of the uplink cell bandwidth with the semi-static part of PUCCH format 1 next and finally the dynamic part of PUCCH format 1 in the innermost part of the bandwidth.

Three semi-statically configured parameters are used to determine the resources to use for the different PUCCH formats:

N_{RB}⁽²⁾, provided as part of the system information, controls on which resource-block pair the mapping of PUCCH format 1 starts;

N_{PUCCH}⁽¹⁾ controls the split between the semi-static and dynamic part of PUCCH format 1;

X controls the mix of format 1 and format 2 in one resource block.

In most cases, the configuration is done such that the two PUCCH formats are mapped to separate sets of resource blocks, but there is also a possibility to have the border between format 1 and 2 within a resource block.

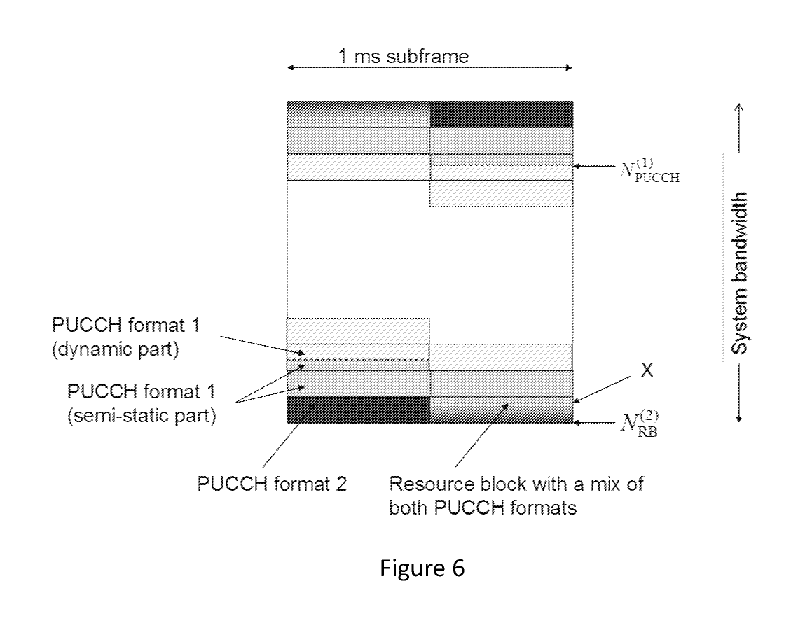

The PUCCH resource allocation in terms of resource blocks are illustrated in FIG. 6. The numbers 0, 1, 2, . . . represent the order in which the resource blocks are allocated to PUCCH, i.e., a large PUCCH configuration may need resource 0-6 while a small configuration may use only 0.

Within the Rel-13 work item on “Further LTE Physical Layer Enhancements for Machine Type Communications” [3GPP Tdoc RP-141660], it has been agreed to provision a new UE class with RF bandwidth of 1.4 MHz (supporting a channel bandwidth of 6 PRBs à 180 kHz) for cost/complexity savings. Within a larger system bandwidth than 1.4 MHz, this narrowband and/or low-complexity (LC) UE (also referred to as terminal or LC terminal in the following) will or has to be able to receive and transmit only over the narrower UE bandwidth. To transmit over a different part of the system bandwidth, the UE may need to retune the center frequency of its radio circuitry and/or receiver and/or transmitter (or corresponding circuitry). During the so-called “frequency retuning time”, the UE will not be able to receive/transmit any signal. The frequency retuning time is expected to be at least in the order of one OFDM symbol and maybe as high as one slot (0.5 ms).

As discussed above, the current PUCCH formats use PRB resources located close to system bandwidth edges within each subframe. If a LC UE reuses the existing PUCCH resource allocation scheme, it will require frequency tuning at the slot boundary during which time it will not transmit anything. Thus, only the latter few OFDM symbols will be transmitted in the second slot, which may cause decoding problems at the network node, e.g. eNodeB.

A new PUCCH format 1A/1B resource allocation scheme for terminals, e.g. LC UEs, is suggested. In this scheme, a terminal/LC UE may use two PUCCH resources, but e.g. may transmit on only one of them in each slot. The resources may be chosen (e.g., by the terminal and/or a resource choosing module of the terminal and/or based on a configuration, which may e.g. be configured by network node) for example such that they do not require any frequency hopping at the slot boundary and/or do not require retuning the center frequency and/or the corresponding radio circuitry.

It may be assumed that transmitting is performed using the same radio circuitry and/or transmitter (circuitry), which may be true even in the case the terminal comprises more than one independently tuneable transmitter/transmitter circuitry. A transceiver may be seen as an implementation of a transmitter.

Generally, there may be considered a method for operating a terminal, which may be a LC terminal or UE, and/or a corresponding terminal may be considered. The method may comprise, and/or the terminal may be adapted for, and/or comprise a transmitting module for, transmitting uplink control information, e.g. in a subframe as described herein. Transmitting may use a format as described herein, wherein the format may utilize the first and the second slot of a subframe. The subframe may generally comprise a first and a second slot. In particular, transmitting may be such that resources for transmitting the uplink control information are chosen and/or are according to a format as described herein.

The method may comprise choosing, and/or the terminal may be adapted for, and/or comprise a resource choosing module for, choosing the resources for transmitting the uplink control information.

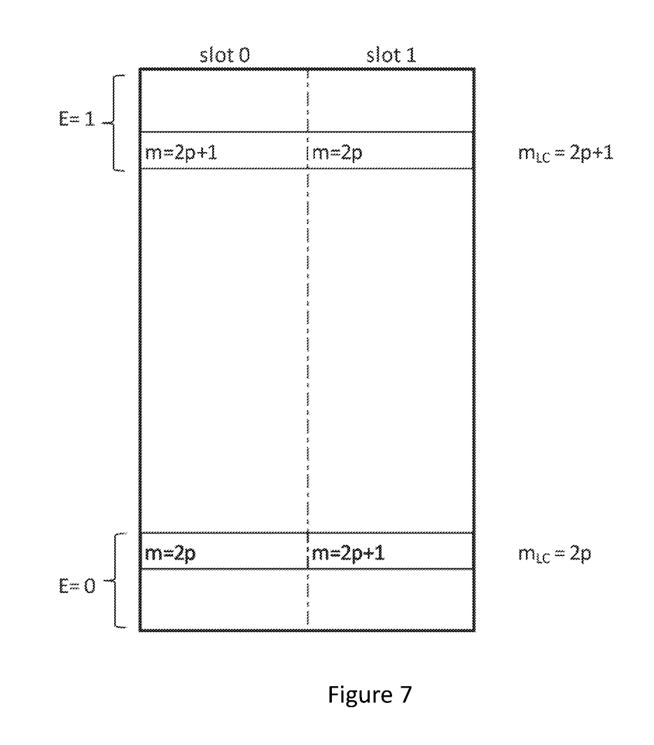

Choosing may comprise determining the format for transmitting. Transmitting may be based on such choosing and/or based on a format as described herein, in particular regarding FIGS. 7 to 12. Transmitting may generally be on uplink resources (e.g., resources scheduled or configured for uplink transmission by a network node). A resource may in particular comprise a subcarrier in a slot of a subframe; resources may comprise one subcarrier in each slot of the subframe, wherein the resources/subcarriers may be used for (and/or be configured for) UCI transmission.

Generally, transmitting and/or choosing may be such that the resources comprise one or at least one resource (and/or subcarrier) in each slot (e.g., the first and the second slots of a subframe), for example such that the resource/s (in particular, a subcarrier of a resource block) in the second slot of a subframe is/are within the bandwidth of the radio circuitry of the terminal used for transmitting on the first slot (e.g., the uplink control information and/or any other data), and/or such that the radio circuitry does not have to be retuned.

It may be considered that transmitting uplink control information in the first slot is performed using a bandwidth (e.g. by correspondingly tuning the terminal and/or its radio/transmitter circuitry, e.g. by the terminal configuring and/or being adapted for configuring, and/or comprising a tuning module for configuring, itself accordingly), the bandwidth covering the frequency resource (e.g., subcarrier) used for transmitting the uplink control information in the first slot and the frequency resource (e.g. subcarrier) used for transmitting the uplink control information in the second slot. The method may comprise configuring the terminal for such transmitting, e.g. based on allocation data received from a network node and/or the choosing. The terminal may be adapted for such configuring and/or for receiving allocation data, and/or comprise a corresponding configuring module and/or receiving module, respectively.

There may generally considered a method for operating a network node, and/or a network node adapted for, and/or comprising a configuring module for, configuring one or more terminals (which may be terminals as described herein) for transmitting uplink control information as described herein and/or according to a format as described herein. In particular, such configuring may comprise configuring more than one terminal to multiplex uplink control information and/or other data as described herein, in particular using the resources of two slots of a subframe such that the terminals transmit on different subcarriers/symbols of each slot, e.g. utilizing the format as described herein.

Alternatively or additionally, there may be considered method for operating a network node comprising, and/or a network node adapted for, and/or comprising a receiving module for, receiving uplink control information from one or more than one terminals according to a format as described herein. The network node, and/or the receiving module of the network node, may be adapted to receive on a narrow bandwidth as described herein. The method may comprise, and/or the network node may be adapted for, and/or comprise a processing module for, processing the received uplink control information. Such processing may include determining allocation data for the terminal/s, e.g. scheduling resources and/or determining power control for the terminal/s and/or the network node, based on the received uplink control information. It may be considered that processing generally comprises configuring one or more terminals.

Configuring one or more terminals (e.g. by a network node, for example before or independent of receiving uplink control information), and/or processing, may comprise scheduling a second terminal or LC UE to use the PUCCH resources that are not used by a first terminal/LC UE and/or configuring or scheduling at least two terminals for sharing and/or multiplexing (multiplexing in this context may pertain to the point of view of the network node receiving the uplink control information, which may receive a multiplexed signal from more than one terminal). This may avoid resource wastage due to partial use of PUCCH resources. This scheme allows terminals/LC UEs to coexist with the legacy UEs without causing any resource collision.

Choosing and/or scheduling of resources may generally comprise mapping of resources, e.g. as described herein.

This solution may allow terminals/LC UEs to use the PUCCH format 1A/1B resources, which may be allocated within a cell, i.e. additional resources do not have to be configured.

LC-PUCCH, e.g. without simultaneous PUSCH, is discussed in the following. For example, LC-PUCCH mapped to both slots in a subframe may be considered.

The resources for uplink control information, e.g. LC-PUCCH, may be mapped to a band/bandwidth edge of the UL system bandwidth when the UE only needs to transmit LC-PUCCH, or if the PUSCH can be mapped to the 6-PRB UE bandwidth together with LC-PUCCH towards the band edge. Choosing and/or configuring and/or scheduling may comprise such mapping. This has the benefit of align the LC-PUCCH to legacy PUCCH region, so that as many as possible consecutive PRBs can be left aside for PUSCH transmission.

FIG. 7 shows example LC-PUCCH location within a subframe.

The physical resources used for PUCCH transmission are denoted by m as described above for legacy UEs, and depends on the PUCCH format. Below E=mod(m_{LC},2) denotes the edge where these physical resources reside (where m_{LC} is a variable that describes the PUCCH resources used by LC UE).
If edge E=0, i.e., m_{LC}=2p, use two PUCCH resources at lower PRB edge with m=m_{LC}, and m=m+1.
If edge E=1, i.e., m_{LC}=2p+1, use two PUCCH resources at higher PRB edge with m=m_{LC}−1, and m=m_{LC}.

For formats 1, 1a and 1 b

$$m = \{ \begin{matrix}{N}_{RB}^{( 2 )} & if {n}_{PUCCH}^{( 1 , \tilde{p} )} < c \cdot {N}_{cs}^{( 1 )} / {Δ}_{shift}^{PUCCH} \\ ⌊ \frac{{n}_{PUCCH}^{( 1 , \tilde{p} )} - c \cdot {N}_{cs}^{( 1 )} / {Δ}_{shift}^{PUCCH}}{c \cdot {N}_{sc}^{RB} / {Δ}_{shift}^{PUCCH}} ⌋ + {N}_{RB}^{( 2 )} + ⌈ \frac{{N}_{cs}^{( 1 )}}{8} ⌉ & otherwise\end{matrix} \\ c = \{ \begin{matrix}3 & normal cyclic prefix \\ 2 & extended cyclic prefix\end{matrix}$$

and for formats 2, 2a and 2b

m=└n_{PUCCH}^{(2,\tilde{p})}/N_{sc}^{RB}┘

and for format 3

m=└n_{PUCCH}^{(3,\tilde{p})}/N_{SF,0}^{PUCCH}┘

The PRB pairs used for LC-PUCCH may be:

$${n}_{PRB} = \{ \begin{matrix}⌊ \frac{m}{2} ⌋ & if ( m + {n}_{s} mod 2 ) mod 2 = 0 \\ {N}_{RB}^{UL} - 1 - ⌊ \frac{m}{2} ⌋ & if ( m + {n}_{s} mod 2 ) mod 2 = 1\end{matrix}$$

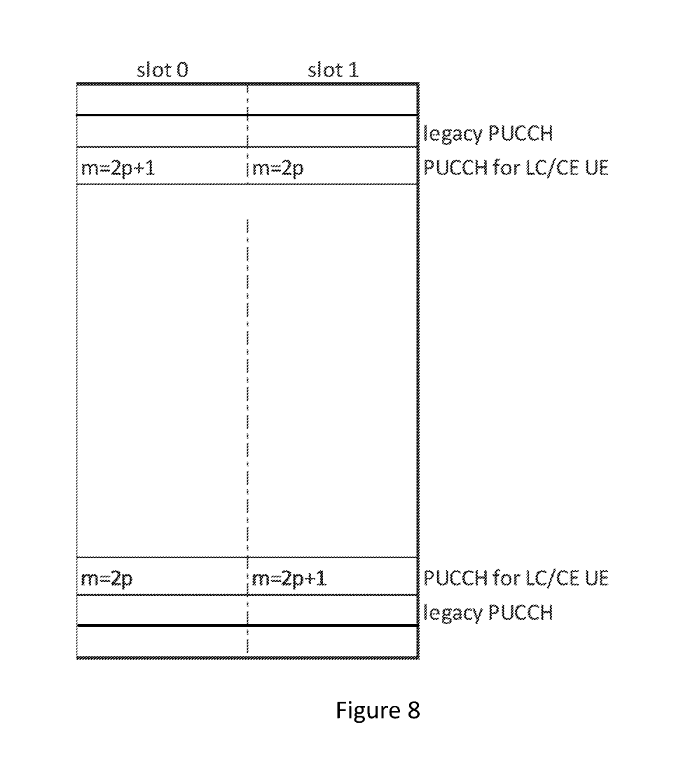

The LC-PUCCH and legacy PUCCH may be scheduled and/or be multiplexed to the two band edges of the UL system BW as shown in FIG. 8.

FIG. 8 shows multiplexing of LC-PUCCH for LC/CE UEs and legacy PUCCHs.

Note that it is also possible to code multiplex LC-PUCCH and legacy PUCCH in the same time-frequency resources (this is not shown in the figure) since they are separated via orthogonal sequences. The orthogonality in code-domain can be achieved via the orthogonal cover code and/or cyclic-shift. However, note that a collision in a slot will occur if the lowest ECCE indices (for LC and legacy) are separated by x=c·N_{cs}⁽¹⁾/Δ_{shift}^{PUCCH}. This is can be avoided by one or both of the following two ways:
An semi-static offset provided by higher layer signaling (i.e., RRC signalling); and/or
A dynamic offset provided by the dynamic scheduling ARO.

For example, if LC-PDCCH-PRB-set q is configured for distributed transmission

n_{PUCCH}^{(1,\tilde{p}}^{₀}⁾=n_{ECCE,q}Δ_{ARO}+N_{PUCCH,q}^{(LC)}

where:
N_{PUCCH,q}^{(LC)} is the semi-static offset provided by RRC signaling;
Δ_{ARO} is an offset provided via DCI.

TABLE 1
Mapping of ACK/NACK Resource offset Field
in DCI to Δ_{ARO} values

| ACK/NACK Resource offset field | |
|---|---|
| in DCI | Δ_{ARO} |
| 0 | 0 |
| 1 | −1 |
| 2 | −2 |
| 3 | 2 |

If repetition across multiple subframes and frequency hopping across subframes are desired, the edge can be a function of subframe index k:

$$E = mod ( ⌊ \frac{k - {k}_{0}}{Y} ⌋ + {m}_{LC} , 2 ) ,$$

where m_{LC} is a same value across the subframes carrying a given PUCCH, including repetitions across subframes, and determined according to the first ECCE index. K0 is the start subframe index of the frequency hopping pattern.

Configuring the terminal, e.g. by the network or network node, may be implemented accordingly, in particular based on table 1.

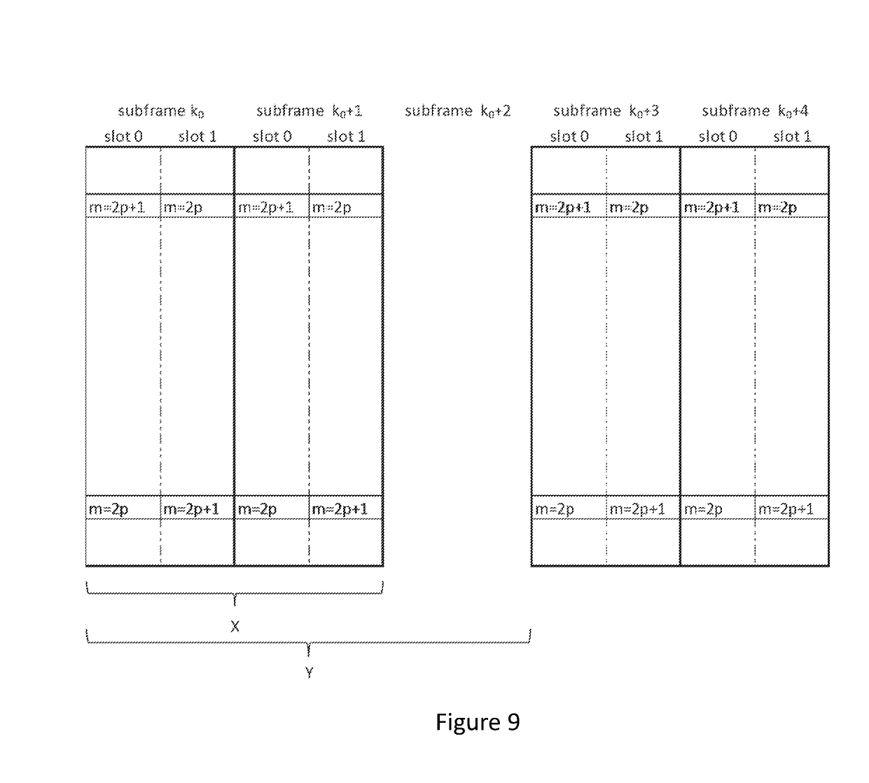

In FIG. 9, it is illustrated how repetition and frequency hopping can be configured for carrying a PUCCH. In order to allow cross-subframe channel estimation, the frequency location (PRB position) is the same during at least X subframes. If/when frequency hopping is applied, frequency location can be switched every Y consecutive subframes, where Y is equal to or larger than X, assuming re-tuning time is included in Y. In the figure below, X=2, Y=3, one UL subframe is reserved for retuning time. Configuring the terminal, e.g. by the network or network node, may be implemented accordingly.

LC-PUCCH of different formats is discussed in the following.

When the terminal/ (LC/CE) UE does not need to send PUSCH in the same subframe as PUCCH, the LC-PUCCH may be multiplexed with legacy PUCCH for various formats:

1. Multiplex LC-PUCCH format 1/1a/1b with legacy PUCCH format 1/1a/1b;

2. Multiplex LC-PUCCH format 2/2a/2b with legacy PUCCH format 2/2a/2b;

3. Multiplex LC-PUCCH format 3 with legacy PUCCH format 3;

Note that due to the need of LC-PUCCH, the number of PRBs for PUCCH format 2/2a/2b N_{RB}⁽²⁾ needs to be configured to account for both legacy PUCCH and LC-PUCCH. Configuring the terminal, e.g. by the network or network node, may be implemented accordingly.

Multiplex of multiple LC-PUCCHs in a given subframe is discussed in the following.

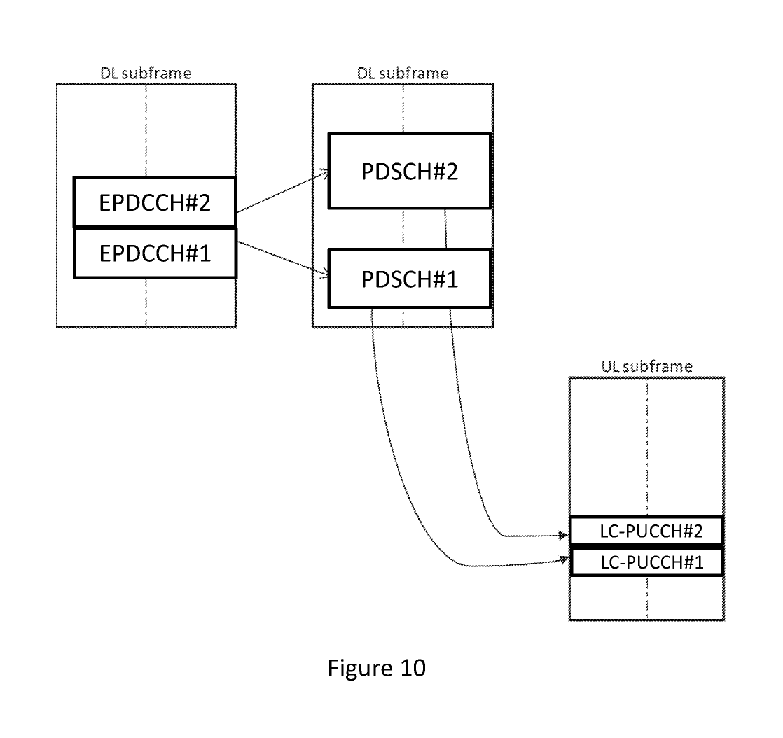

In FIG. 10, it is illustrated that two LC-PUCCH of two LC/CE UEs, respectively, are multiplexed in the same PUCCH resource region a subframe. The two LC-PUCCH may have the same PUCCH format, or different PUCCH formats, depending on the content each LC-PUCCH is carrying.

In one alternative, the LC-PUCCH of LC/CE UEs are mapped to the legacy PUCCH resource region, which is composed of PRBs towards both edges of the UL system BW. The LC-PUCCH of one LC/CE UE is mapped to a single edge of the UL system BW, i.e., two slots of a PRB pair of the same PRB index. The LC-PUCCH of two different LC/CE UE can be mapped to the same edge (as shown in FIG. 10), or different edges of the UL system BW, defining on the PUCCH resource index of each UE.

In another alternative, the LC-PUCCH of LC/CE UEs are mapped to a PUCCH resource region dedicated to LC/CE UEs (i.e., separate from the legacy PUCCH region at the band edge). For instance, such PUCCH resource region is a group of M consecutive PRBs on the UL, M<=6. One or more PUCCH resource regions can be defined in a subframe.

Two LC/CE UEs configured to use the same PUCCH resource region in a subframe have their LC-PUCCH mapped to the given PUCCH resource region, where their LC-PUCCH transmission is separated via PRB location, cyclic shift, or orthogonal cover code. This is also illustrated by FIG. 10, when the region that LC-PUCCHs map to is different from the legacy PUCCH region.

Two LC/CE UEs can also be configured to use different PUCCH resource regions in a subframe. This may be due to that the two LC/CE UEs are configured to follow two different UL frequency-hopping patterns.

Configuring the terminal, e.g. by the network or network node, may be implemented accordingly.

LC-PUCCH with simultaneous PUSCH is discussed in the following.

When there is simultaneous LC-PUCCH and PUSCH within a subframe, the PRB resources for LC-PUCCH and PUSCH may have to reside in the same bandwidth, e.g. a 6-PRB UE bandwidth. Thus LC-PUCCH may not be multiplexed or multiplexable with legacy PUCCH.

However, the LC-PUCCH construction can still use the methods described herein. That is, a LC-PUCCH may be mapped to both slots of a PRB pair that have the same PRB index.

In this case, the LC-PUCCH may share the same frequency-hopping pattern as PUSCH. The frequency hopping pattern is configured semi-statically, and it designates the 6-PRB UL resources that the UE uses for all UL transmission in a subframe. The frequency hopping pattern then provides the semi-statically provided offset for LC-PUCCH. For example, the PRB pairs used for LC-PUCCH are:

$${n}_{PRB} ( k ) = {N}_{PRB , hop} ( k ) + ⌊ \frac{m}{2} ⌋$$

where N_{PRB,hop}(k) is the lowest PRB index in subframe k according to the frequency hopping pattern configured to the UE. A group of terminals/ UEs may be configured (e.g., by the network or a network node, which may be adapted to configure one or more terminals and/or LC UEs, and/or may comprise a configuring module for such configuring) thusly and/or to share the same frequency hopping pattern, and/or frequency hopping patterns that designate overlapping UL resources in subframe k. Configuring the terminal, e.g. by the network or network node, may be implemented accordingly.

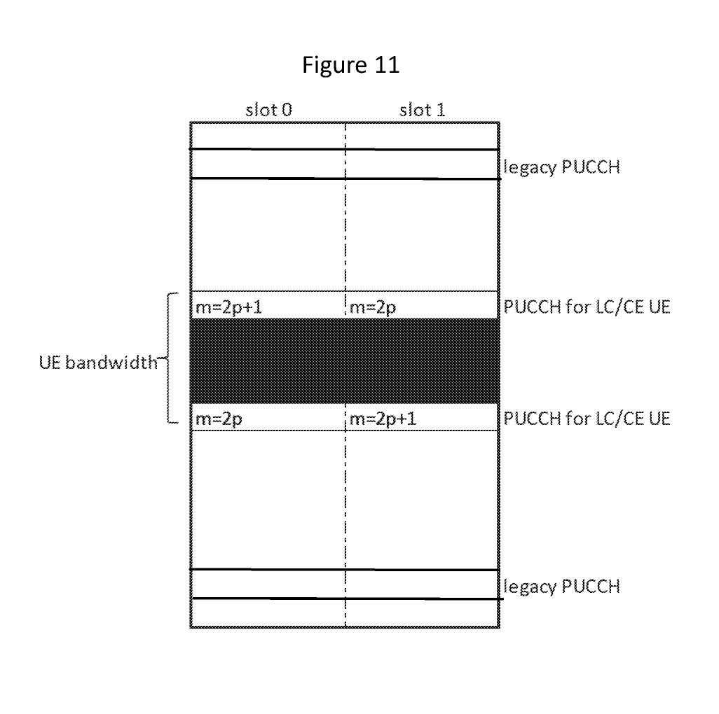

In this case, LC-PUCCH of the UEs may be multiplexed into one 6-PRB UE bandwidth. This is illustrated in FIG. 11, where two LC-PUCCH of two UEs are mapped to the upper and lower edges of the UE bandwidth.

FIG. 11 shows an example of multiplexing of an LC-PUCCH and a PUSCH in an UL subframe.

In FIG. 12, the multiplexing of LC-PUCCH and PUSCH in a same subframe is illustrated. The LC-PUCCH and the PUSCH reside within the 6-PRB UE bandwidth. The PUSCH is scheduled by an earlier EPDCCH, and the LC-PUCCH is sent in response to an earlier PDSCH. While only one LC-PUCCH is illustrated in FIG. 12, it is possible that multiple LC-PUCCHs are multiplexed onto the same UE bandwidth, where the LC-PUCCH may carry HARQ-ACK, SR, and various types of channel state information (CSI). Configuring the terminal, e.g. by the network or network node, may be implemented accordingly.

FIG. 12 shows an example of multiplexing of an LC-PUCCH and a PUSCH in an UL subframe.

It is noted that while in the above a terminal/UE bandwidth is assumed to be 6 PRB in size, this is only an example and other sizes are possible. For example, the UE bandwidth may be 4 PRB in size, 5 PRB in size, etc. The bandwidth of a PRB may be determined according to a standard, e.g. LTE.

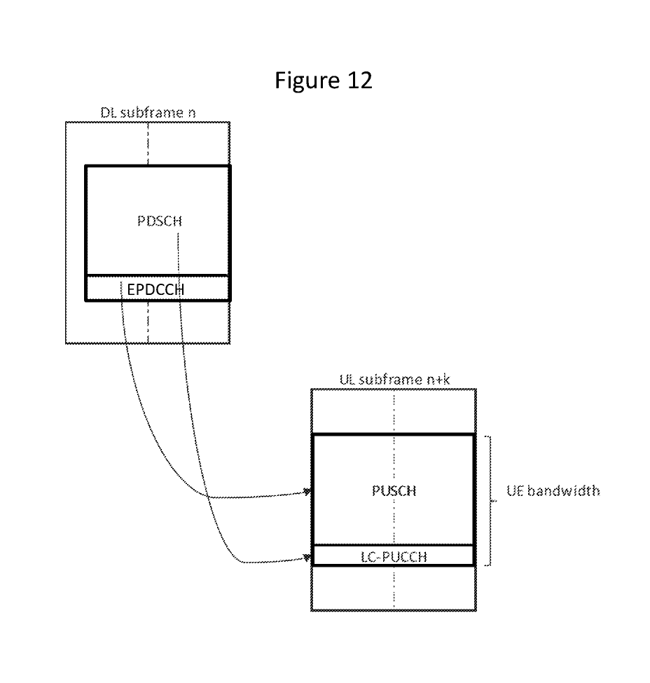

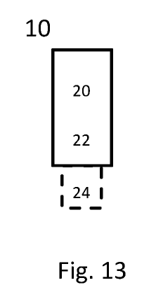

FIG. 13 schematically shows a terminal 10, which may be implemented in this example as a user equipment. Terminal 10 comprises control circuitry 20, which may comprise a controller connected to a memory. Any of the modules of a terminal described herein may be implemented in and/or executable by, the control circuitry 20, in particular as module in the controller. Terminal 10 also comprises radio circuitry 22 providing receiving and transmitting or transceiving functionality, the radio circuitry 22 connected or connectable to the control circuitry. An antenna circuitry 24 of the terminal 10 is connected or connectable to the radio circuitry 22 to collect or send and/or amplify signals. Radio circuitry 22 and the control circuitry 20 controlling it are configured for cellular communication with a network on a first cell/carrier and a second cell/carrier, in particular utilizing E-UTRAN/LTE resources as described herein. The terminal 10 may be adapted to carry out any of the methods for operating a terminal disclosed herein; in particular, it may comprise corresponding circuitry, e.g. control circuitry. Modules of a terminal as described herein may be implemented in software and/or hardware and/or firmware in corresponding circuitry.

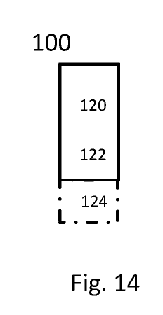

FIG. 14 schematically show a network node or base station 100, which in particular may be an eNodeB. Network node 100 comprises control circuitry 120, which may comprise a controller connected to a memory. The control circuitry is connected to control radio circuitry 122 of the network node 100, which provides receiver and transmitter and/or transceiver functionality. An antenna circuitry 124 may be connected or connectable to radio circuitry 122 for signal reception or transmittance and/or amplification. The network node 100 may be adapted to carry out any of the methods for operating a network node disclosed herein; in particular, it may comprise corresponding circuitry, e.g. control circuitry. Modules of a network node as described herein may be implemented in software and/or hardware and/or firmware in corresponding circuitry.

Some useful abbreviations comprise:
CCE Control channel element
CE Coverage enhanced/enhancement
DCI Downlink control information
EPDCCH Enhanced physical downlink control channel
LC Low cost/complexity
MTC Machine type communications
PDSCH Physical downlink shared channel
PRB Physical resource block
PUCCH Physical uplink control channel
3GPP 3rd Generation Partnership Project
Ack/Nack Acknowledgment/Non-Acknowledgement, also A/N
AP Access point Bandwidth of signals, in particular carrier bandwidth Bn assigned to
B1, B2, . . . Bn corresponding carrier or frequency f1, f2, . . . , fn
BER/BLER Bit Error Rate, BLock Error Rate;
BS Base Station
CA Carrier Aggregation
CCA Clear Channel Assessment
CIS Transmission Confirmation Signal
CoMP Coordinated Multiple Point Transmission and Reception
CQI Channel Quality Information
CRS Cell-specific Reference Signal
CSI Channel State Information
CSI-RS CSI reference signal
D2D Device-to-device
DCI Downlink Control Information
DL Downlink
DL Downlink Downlink; generally referring to transmission of data to a node/into a direction further away from network core (physically and/or logically); in particular from a base station or eNodeB terminal; more generally, may refer to transmissions received by a terminal or node (e.g. in a D2D environment); often uses specified
DL spectrum/bandwidth different from UL (e.g. LTE)
DMRS Demodulation Reference Signals
DRS Discovery Reference Signal
eNB evolved NodeB, base station
eNB evolved NodeB; a form of base station, also called eNodeB
EPDCCH Enhanced Physical DL Control CHannel
E-UTRA/N Evolved UMTS Terrestrial Radio Access/Network, an example of a RAT carriers/carrier frequencies; different numbers may indicate that the referenced
f1, f2, f3, . . . , fn carriers/frequencies are different
f1_DL, . . . , fn_DL Carrier for Downlink/in Downlink frequency or band
f1_UL, . . . , fn_UL Carrier for Uplink/in Uplink frequency or band
FDD Frequency Division Duplexing
HARQ Hybrid Automatic Repeat reQuest
ID Identity
L1 Layer 1
L2 Layer 2
LA Licensed Assisted
LA Licensed Assisted Access
LBT Listen-before-talk
LTE Long Term Evolution, a telecommunications standard
MAC Medium Access Control
MBSFN Multiple Broadcast Single Frequency Network
MCS Modulation and Coding Scheme
MDT Minimization of Drive Test
NW Network
O&M Operational and Maintenance
OFDM Orthogonal Frequency Division Multiplexing
OSS Operational Support Systems
PC Power Control
PCFICH Physical Control Format Indicator Channel
PDCCH Physical Downlink Control Channel
PDCCH Physical DL Control CHannel
PH Power Headroom
PHR Power Headroom Report
PMI Precoding Matrix Indicator
PRB Physical Resource Block
PSS Primary Synchronization Signal
PUCCH Physical Uplink Control Channel
PUSCH Physical Uplink Shared Channel
PUSCH Physical Uplink Shared CHannel
RA Random Access
RACH Random Access CHannel
RAT Radio Access Technology
RB Resource Block
RE Resource Element
RI Rank Indicator
RRC Radio Resource Control
RRH Remote radio head
RRM Radio Resource Management
RRM Radio Resource Management
RRU Remote radio unit
RSRP Reference signal received power
RSRQ Reference signal received quality
RSSI Received signal strength indicator
RX reception/receiver, reception-related
SA Scheduling Assignment
SCell Secondary Cell
SFN Single Frequency Network
SINR/SNR Signal-to-Noise-and-Interference Ratio; Signal-to-Noise Ratio
SON Self Organizing Network
SR Scheduling Request
SRS Sounding Reference Signal
SSS Secondary Synchronization Signal
TDD Time Division Duplexing
TPC Transmit Power Control
TTI Transmission-Time Interval
TX transmission/transmitter, transmission-related
UE User Equipment
UL Uplink; generally referring to transmission of data to a node/into a direction closer to a network core (physically and/or logically); in particular from a D2D enabled node or UE to a base station or eNodeB; in the context of D2D, it may refer to the spectrum/bandwidth utilized for transmitting in D2D, which may be the same used for UL communication to a eNB in cellular communication; in some D2D variants, transmission by all devices involved in D2D communication may in some variants generally be in UL spectrum/bandwidth/carrier/frequency; generally, UL may refer to transmission by a terminal (e.g. to a network or network node or another terminal, for example in a D2D context).

These and other abbreviations may be used according to LTE standard definitions. It may be considered that a HARQ signaling format comprises and/or determines and/or defines a modulation and/or number of symbols and/or a coding, e.g. for a HARQ transmission, e.g. to be utilized and/or which is utilized for HARQ transmission (e.g. for modulating and/or coding HARQ information and/or HARQ data, for example ACK/NACK and/or corresponding HARQ identifiers), in particular to be used by a terminal and/or UE (for encoding) and/or a network node (for decoding). It should be noted that for each coding, there may be an encoding and a corresponding decoding, which may be associated to each other in a reversible manner, such that encoded data may be decoded (and vice versa) in a reproducible and reversible manner (the latter possibly within a given probability of error) such that decoded data corresponds to the data encoded. Generally, a HARQ signaling format may determine and/or define and/or indicate the number of bits a HARQ data block (after modulating and/or encoding the HARQ data to be transmitted within a block) contains.

Coding may comprise error detection coding and/or forward error correction coding (which may also be referred to as channel coding or channel encoding). Coding may generally comprise encoding (e.g., by a UE and/or a corresponding module of the UE) and/or decoding (e.g., by a network node and/or a corresponding module of the node). Encoding in particular may pertain to HARQ data or information, which may comprise ACK/NACK signaling (e.g., one or more ACK/NACK bits) and/or corresponding identifiers, e.g. a HARQ process identifier. Such data or information may comprise channel state information or channel quality information and/or information pertaining to measurements performed by the terminal, e.g. encoded (coded) into a common block of data (e.g. a transport block or block of HARQ information or HARQ data or HARQ data block), Coding HARQ information may generally be performed by a terminal or UE, decoding HARQ information may be performed by a network node. To a coding (in particular encoding), a number of encoding bits (which may be called coding size or coding length) may be associated.

For decoding, the decoding node (e.g. network node) may assume a format or coding, e.g. based on DL carrier number and/or a configuration provided to the encoding node, e.g. terminal or UE (the terminal or UE may generally be adapted to acknowledge receipt of a configuration to the configuring node, e.g. network node).

There may be considered a network node adapted for performing any one of the methods for operating a network node described herein and/or for configuring a terminal as described herein.

There may be considered a terminal adapted for performing any one of the methods for operating a terminal described herein and/or for performing bundling as described herein, in particular according to a configuration configured by a network or network node or system.

There is also disclosed a program product comprising code executable by control circuitry, the code causing the control circuitry to carry out and/or control any one of the method for operating a terminal or network node as described herein, in particular if executed on control circuitry, which may be control circuitry of a terminal or a network node as described herein.

Moreover, there is disclosed a storage medium or carrier medium carrying and/or storing at least any one of the program products described herein and/or code executable by control circuitry, the code causing the control circuitry to perform and/or control at least any one of the methods described herein. Generally, a carrier medium may be accessible and/or readable and/or receivable by control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

An uplink carrier may generally be or indicate a carrier and/or frequency band intended and/or used for uplink transmissions.

A downlink carrier may generally be or indicate a carrier and/or frequency band intended and/or used for downlink transmissions.

A terminal being configured with a cell and/or carrier may be in a state in which it may communicate (transmit and/or receive data) using the cell or carrier, e.g. being registered with the network for communication and/or being synchronized to the cell and/or carrier.

Generally, a node being connected or connectable to a terminal with and/or via a cell or carrier may be adapted for communicating and/or communicate with the terminal using this cell or carrier and/or comprise a corresponding communication link. A terminal being connected or connectable to a network with a cell or carrier may be adapted for communicating and/or communicate with the terminal using this cell or carrier. Connection to a network may refer to connection to at least one node of the network.

Data may refer to any kind of data, in particular any one of and/or any combination of control data or user data or payload data. Control data may refer to data controlling and/or scheduling and/or pertaining to the process of data transmission and/or the network or terminal operation.

Receiving or transmitting on a cell or carrier may refer to receiving or transmitting utilizing a frequency (band) or spectrum associated to the cell or carrier.

A wireless communication network may comprise at least one network node, in particular a network node as described herein. A terminal connected or communicating with a network may be considered to be connected or communicating with at least one network node, in particular any one of the network nodes described herein.

In the context of this description, wireless communication may be communication, in particular transmission and/or reception of data, via electromagnetic waves and/or an air interface, in particular radio waves, e.g. in a wireless communication network and/or utilizing a radio access technology (RAT). The communication may involve one or more than one terminal connected to a wireless communication network and/or more than one node of a wireless communication network and/or in a wireless communication network. It may be envisioned that a node in or for communication, and/or in, of or for a wireless communication network is adapted for communication utilizing one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes and/or terminals of the communication. It may, e.g., include address data referring to a node or terminal of the communication and/or data pertaining to the transmission mode and/or spectral configuration and/or frequency and/or coding and/or timing and/or bandwidth as data pertaining to the process of communication or transmission, e.g. in a header. Each node or terminal involved in communication may comprise radio circuitry and/or control circuitry and/or antenna circuitry, which may be arranged to utilize and/or implement one or more than one radio access technologies. Radio circuitry of a node or terminal may generally be adapted for the transmission and/or reception of radio waves, and in particular may comprise a corresponding transmitter and/or receiver and/or transceiver, which may be connected or connectable to antenna circuitry and/or control circuitry. Control circuitry of a node or terminal may comprise a controller and/or memory arranged to be accessible for the controller for read and/or write access. The controller may be arranged to control the communication and/or the radio circuitry and/or provide additional services. Circuitry of a node or terminal, in particular control circuitry, e.g. a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field-Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered.

A node of a wireless communication network may be implemented as a terminal and/or user equipment and/or base station and/or relay node and/or any device generally adapted for communication in a wireless communication network, in particular cellular communication.

A modulation for HARQ/ACK transmission may comprise a number of symbols Q′ used for modulation and/or an encoding and/or a format, e.g. an extended format, which may comprise the number of bits to modulate. Allocation data pertaining to modulation may comprise data indicating (e.g. to a terminal), a number of symbols Q′ to be used for modulation and/or an encoding and/or a format, e.g. an extended format, which may comprise the number of bits to modulate.

A cellular network may comprise a network node, in particular a radio network node, which may be connected or connectable to a core network, e.g. a core network with an evolved network core, e.g. according to LTE. A network node may e.g. be a base station. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation. Operation and/or communication and/or exchange of signals without involvement of layers above a base station and/or without utilizing a predefined cell structure provided by a base station or eNB, may be considered to be D2D communication or operation, in particular, if it utilizes the radio resources, in particular carriers and/or frequencies, and/or equipment (e.g. circuitry like radio circuitry and/or antenna circuitry, in particular transmitter and/or receiver and/or transceiver) provided and/or used for cellular operation.

A terminal may be implemented as a mobile terminal and/or user equipment. A terminal or a user equipment (UE) may generally be a device configured for wireless device-to-device communication and/or a terminal for a wireless and/or cellular network, in particular a mobile terminal, for example a mobile phone, smart phone, tablet, PDA, etc. A user equipment or terminal may be a node of or for a wireless communication network as described herein, e.g. if it takes over some control and/or relay functionality for another terminal or node. It may be envisioned that terminal or a user equipment is adapted for one or more RATs, in particular LTE/E-UTRA. A terminal or user equipment may generally be proximity services (ProSe) enabled, which may mean it is D2D capable or enabled. It may be considered that a terminal or user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. It may be considered that a terminal or user equipment is configured to be a terminal or user equipment adapted for LTE/E-UTRAN. Generally, a terminal may be adapted for MTC (machine-type communication). Such a terminal may be implemented as or associated to a sensor/sensor arrangement and/or smart device and/or lighting/lighting arrangement and/or remotely controlled and/or monitored device (e.g., smart-meter).

A network node may be a base station, which may be any kind of base station of a wireless and/or cellular network adapted to serve one or more terminals or user equipments. It may be considered that a base station is a node or network node of a wireless communication network. A network node or base station may be adapted to provide and/or define and/or to serve one or more cells of the network and/or to allocate frequency and/or time resources for communication to one or more nodes or terminals of a network. Generally, any node adapted to provide such functionality may be considered a base station. It may be considered that a base station or more generally a network node, in particular a radio network node, comprises radio circuitry and/or control circuitry for wireless communication. It may be envisioned that a base station or network node is adapted for one or more RATs, in particular LTE/E-UTRA. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. A base station may be arranged to be a node of a wireless communication network, in particular configured for and/or to enable and/or to facilitate and/or to participate in cellular communication, e.g. as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station, e.g. according to an LTE standard. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a coordinating node and/or to allocate resources in particular for cellular communication between two nodes or terminals of a wireless communication network, in particular two user equipments.

It may be considered for cellular communication there is provided at least one uplink (UL) connection and/or channel and/or carrier and at least one downlink (DL) connection and/or channel and/or carrier, e.g. via and/or defining a cell, which may be provided by a network node, in particular a base station or eNodeB. An uplink direction may refer to a data transfer direction from a terminal to a network node, e.g. base station and/or relay station. A downlink direction may refer to a data transfer direction from a network node, e.g. base station and/or relay node, to a terminal. UL and DL may be associated to different frequency resources, e.g. carriers and/or spectral bands. A cell may comprise at least one uplink carrier and at least one downlink carrier, which may have different frequency bands. A network node, e.g. a base station or eNodeB, may be adapted to provide and/or define and/or control one or more cells, e.g. a PCell and/or a LA cell.

A network node, in particular a base station, and/or a terminal, in particular a UE, may be adapted for communication in spectral bands (frequency bands) licensed and/or defined for LTE. In addition, a network node, in particular a base station/eNB, and/or a terminal, in particular a UE, may be adapted for communication in freely available and/or unlicensed/LTE-unlicensed spectral bands (frequency bands), e.g. around 5 GHz. Configuring a terminal or wireless device or node may involve instructing and/or causing the wireless device or node to change its configuration, e.g. at least one setting and/or register entry and/or operational mode. A terminal or wireless device or node may be adapted to configure itself, e.g. according to information or data in a memory of the terminal or wireless device. Configuring a node or terminal or wireless device by another device or node or a network may refer to and/or comprise transmitting information and/or data and/or instructions to the wireless device or node by the other device or node or the network, e.g. allocation data and/or scheduling data and/or scheduling grants. Configuring a terminal may include sending allocation data to the terminal indication which modulation and/or encoding to use. A terminal may be configured with and/or for scheduling data and/or to use, e.g. for transmission, scheduled and/or allocated uplink resources, and/or, e.g. for reception, scheduled and/or allocated downlink resources. Uplink resources and/or downlink resources may be scheduled and/or provided with allocation or configuration data.

A modulation of and/or modulating HARQ/ACK information/feedback may include an encoding and/or performing encoding. Allocation data configuring or indicating a modulation may include an indication which encoding to use for HARQ/ACK information/feedback. The term modulation may be used to refer to data (e.g. allocation data) representing and/or indicating the modulation used and/or to be used by a terminal.

A wireless communication network may comprise a radio access network (RAN), which may be adapted to perform according to one or more standards, in particular LTE, and/or radio access technologies (RAT).

A network device or node and/or a wireless device may be or comprise a software/program arrangement arranged to be executable by a hardware device, e.g. control circuitry, and/or storable in a memory, which may provide the described functionality and/or corresponding control functionality.

A cellular network or mobile or wireless communication network may comprise e.g. an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g. LTE FDD, LTE TDD, GSM, CDMA, WCDMA, WiFi, WLAN, WiMAX, etc.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g. an optical disc and/or magnetic memory and/or a volatile or non-volatile memory and/or flash memory and/or RAM and/or ROM and/or EPROM and/or EEPROM and/or buffer memory and/or cache memory and/or a database.

Resources or communication resources or radio resources may generally be frequency and/or time resources (which may be called time/frequency resources). Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated (or scheduled) resources may in particular refer to UL resources, e.g. UL resources for a first wireless device to transmit to and/or for a second wireless device. Transmitting on allocated resources and/or utilizing allocated resources may comprise transmitting data on the resources allocated, e.g. on the frequency and/or subcarrier and/or carrier and/or timeslots or subframes indicated. It may generally be considered that allocated resources may be released and/or de-allocated. A network or a node of a network, e.g. an allocation or network node, may be adapted to determine and/or transmit corresponding allocation data indicating release or de-allocation of resources to one or more wireless devices, in particular to a first wireless device.

Allocation data may be considered to be data scheduling and/or indicating and/or granting resources allocated by the controlling or allocation node, in particular data identifying or indicating which resources are reserved or allocated for communication for a wireless device or terminal and/or which resources a wireless device or terminal may use for communication and/or data indicating a resource grant or release, in particular pertaining to uplink and/or downlink resources. A grant or resource or scheduling grant or scheduling data (which, in particular, may pertain to information regarding and/or representing and/or indicating scheduling of resources) may be considered to be one example of allocation data. Allocation data may in particular comprise information and/or instruction regarding a configuration and/or for configuring a terminal, e.g. indicating a scheduling and/or a modulation to use, which may comprise an encoding and/or a number of symbols Q′ to be used. Such information may comprise e.g. information about which carriers (and/or respective HARQ feedback) to bundle, bundle size, method to bundle (e.g. which operations to perform, e.g. logical operations), etc., in particular information pertaining to and/or indicating the embodiments and methods described herein. It may be considered that an allocation node or network node is adapted to transmit allocation data directly to a node or wireless device and/or indirectly, e.g. via a relay node and/or another node or base station.

Allocation data may comprise control data and/or be part of or form a message, in particular according to a pre-defined format, for example a DCI format, which may be defined in a standard, e.g. LTE. Allocation data may comprise configuration data, which may comprise instruction to configure and/or set a user equipment for a specific operation mode, e.g. in regards to the use of receiver and/or transmitter and/or transceiver and/or use of transmission (e.g. TM) and/or reception mode, and/or may comprise scheduling data, e.g. granting resources and/or indicating resources to be used for transmission and/or reception. A scheduling assignment may be considered to represent scheduling data and/or be seen as an example of allocation data. A scheduling assignment may in particular refer to and/or indicate resources to be used for communication or operation.

HARQ ACK/NACK (acknowledge for a correctly received block of data, not acknowledged for a not correctly received block of data) feedback may refer to feedback (e.g. a corresponding signal transmitted, which may comprise 1 or more bits) provided (e.g. on the UL) by a terminal, e.g. to a network or network node in response to data transmitted to it (e.g. on the DL). HARQ ACK//NACK information or feedback (or shorter HARQ-ACK information or feedback or HARQ information or feedback or just HARQ) may include transmitting a signal/bot indicating whether a transport block of data received by the terminal has been receiver correctly or not. HARQ and/or determining HARQ may include decoding and/or error detection procedures to determine correct reception. There may be defined a number of HARQ processes with associated HARQ ids or numbers, which may refer to individual data streams; a HARQ response or feedback from a terminal (e.g. a HARQ bit) may be associated to one of the HARQ processes or ids. In some variant, HARQ feedback may comprise one bit per DL carrier; in other variant, HARQ feedback may comprise two (or more than two) bits per carrier, e.g. dependent on the rank used. Generally, HARQ feedback may be transmitted (and/or determined, e.g. based on received signals and/or transport blocks and/or data and/or HARQ process identifiers) by a terminal, and/or a terminal may be adapted for, and/or comprise a HARQ module for, determining (e.g., as mentioned above) and/or transmitting HARQ feedback, in particular based on and/or using a configuration and/or a modulation configured, e.g. a modulation determined and/or configured as described herein. Transmitting HARQ may generally be performed on a UL control channel, e.g. PUSCH.

A coding type and/or code and/or corresponding algorithm may be for error detection coding or channel coding. A coding type for channel coding may in particular be a convolutional code or turbo code or RM code

A wireless device may generally be a terminal, e.g. a user equipment.

An uplink resource may be a resource scheduled and/or used for uplink transmission, e.g., by a terminal, and/or for reception of such transmission, e.g. by a network node or base station. A downlink resource may be a resource scheduled and/or used for downlink transmission, e.g. by a base station or network node, and/or for reception of such transmission, e.g. by a terminal.

A channel may generally be a physical channel, in particular a control channel, e.g. PUCCH. A control channel may be used for and/or carry control information, an uplink control channel for example uplink control information.

Data and/or information may generally be transmitted and/or received as signal/s, which may be carried on a time-frequency resource and/or carrier and/or subcarrier.

A terminal may generally be adapted for transmission and/or reception with a RF bandwidth of 1.4 MHz and/or supporting a channel bandwidth of 6 PRBs à 180 kHz, e.g. for cost/complexity savings, in particular pertaining to control information like uplink control information and/or using an uplink control channel like PUCCH (which may be called LC control channel, or in particular LC-PUCCH, if associated and/or carried on such a channel/bandwidth. This may be in addition or instead of the terminal being adapted for transmission and/or reception at a larger system bandwidth than 1.4 MHz. A thus adapted terminal may be called narrowband and/or low-complexity (LC) terminal or UE (also referred to as terminal or LC terminal herein).

1-6. (canceled)

7. A method for operating a terminal in a wireless communication network, the terminal being a narrowband terminal comprising radio circuitry, the method comprising transmitting uplink control information on resources, the resources comprising at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.

8. A terminal for a wireless communication network, wherein the terminal is a narrowband terminal comprising radio circuitry, the terminal further being adapted for transmitting uplink control information on resources, the resources comprising at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.

9. A method for operating a network node in a wireless communication network, the method comprising configuring a narrowband terminal comprising radio circuitry for transmitting uplink control information on resources, the resources comprising at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.

10. A network node for a wireless communication network, the network node being adapted for configuring a narrowband terminal comprising radio circuitry for transmitting uplink control information on resources, the resources comprising at least one subcarrier in the first slot of a subframe and at least one subcarrier in the second slot of the subframe, such that the subcarrier in the second slot of the subframe is within the bandwidth of the radio circuitry of the narrowband terminal used for transmitting in the first slot of the subframe.
